(19) United States
(12) Patent Application Publication
(10) Pub. No.: US 2025/0093233 A1
(43) Pub. Date: Mar. 20, 2025

(54) DRIVING MODULE TESTING DEVICE FOR AN ELECTRIC VEHICLE

(71) Applicants: HYUNDAI MOTOR COMPANY, Seoul (KR); KIA CORPORATION, Seoul (KR)

(72) Inventor: Seung Min Choi, Gunpo-si (KR)

(73) Assignees: HYUNDAI MOTOR COMPANY, Seoul (KR); KIA CORPORATION, Seoul (KR)

(21) Appl. No.: 18/757,116

(22) Filed: Jun. 27, 2024

(30) Foreign Application Priority Data
Sep. 18, 2023 (KR) 10-2023-0123683

(51) Int. Cl. G01M 13/025; G01L 3/16; G01M 17/007

(52) U.S. Cl. CPC G01M 13/025; G01L 3/16; G01M 17/0072

(57) ABSTRACT

A driving module testing device for an electric vehicle includes: i) a pallet fixing a driving module for an electric vehicle and transported along a transport path set by a conveyor; ii) an excitation unit installed at a position that corresponds to the transport path to apply vibration to the driving module by using the pallet; and iii) a dynamometer unit movable in a direction that intersects the transport path to apply a dyno load to an output unit of the driving module.

### CROSS-REFERENCE TO RELATED APPLICATION

This application claims priority to and the benefit of Korean Patent Application No. 10-2023-0123683 filed in the Korean Intellectual Property Office on Sep. 18, 2023, the entire contents of which are incorporated herein by reference.

### BACKGROUND

### (a) Field of the Disclosure

The disclosure relates to a driving module testing device for an electric vehicle, and more particularly, to a driving module testing device for an electric vehicle that allows inspection of the performance and durability of the driving module for an electric vehicle.

### (b) Description of the Related Art

In general, unlike an internal combustion engine vehicle that uses an engine, an electric vehicle may be equipped with a power electric (PE) system, which is a driving module including a combination of an electric motor and a reducer.

Here, the power electric (PE) system (hereinafter referred to as the ‘driving module’) is a modular component in which the electric motor for driving a vehicle, the reducer, an inverter, a controller, and a cooling unit are integrated with each other.

Meanwhile, at a design and development step of the driving module, testing or inspection of the driving module may be an essential prerequisite to verify the performance and durability of the driving module. Typical testing or inspection of the driving module may include an excitation test and a dynamometer load test, i.e., a dyno load test or dyno test.

The excitation test is an inspection of testing the durability of the driving module by applying vibration to the driving module. In addition, the dyno load test is an inspection of testing a load on an output shaft of the driving module.

However, the excitation test and dyno load test of the driving module are separately performed in a testing process of the design and development step of the driving module.

Therefore, it is impossible to predict a problem or a risk that may occur in an environment of actual vehicle conditions, where driving and vibration are mixed with each other. Accordingly, when a quality problem with the driving module occurs during actual vehicle usage, this problem may result in a loss of design and development costs.

The above information disclosed in this Background section is provided only to assist in better understanding of the background of the disclosure. Therefore, the Background section may include information not included in the prior art already known to those of ordinary skill in the art to which the disclosure pertains.

### SUMMARY

The disclosure provides a driving module testing device for an electric vehicle that simulates an environment of actual vehicle conditions by using a simple configuration during a design and development stage of a driving module and allows an integrated excitation test and dyno load test of the driving module.

According to an embodiment, a driving module testing device is provided for an electric vehicle. The device includes: i) a pallet fixing a driving module for an electric vehicle and transported along a transport path set by a conveyor; ii) an excitation unit disposed at a position corresponding to the transport path to apply vibration to the driving module by using the pallet; and iii) a dynamometer unit installed to be movable in a direction that intersects the transport path to apply a dyno load to an output unit of the driving module.

The dynamometer unit may include a rail frame and a slide frame slidably coupled to the rail frame in the direction that intersects the transport path.

Rail frames may be respectively disposed on both sides of the conveyor with the conveyor therebetween in the direction that intersects the transport path.

According to an embodiment, a driving module testing device for an electric vehicle is provided. The device includes: i) a pallet fixing a driving module for an electric vehicle and transported along a transport path set by a conveyor; ii) an excitation unit disposed at a position corresponding to the transport path to apply vibration to the driving module by using the pallet; iii) a slide frame slidably mounted on a rail frame disposed in a direction that intersects the transport path; iv) a dyno load motor installed on the slide frame; v) a constant velocity universal joint connected to the dyno load motor; and vi) a driving shaft module connected to the constant velocity universal joint to be docked to an output unit of the driving module.

The device may further include a docking guide module supporting the driving shaft module and fixed to the rail frame to guide the driving shaft module to the driving module while allowing rotation of the driving shaft module.

The dyno load motor may be connected to the constant velocity universal joint through a coupler in which a torque sensor is installed.

The constant velocity universal joint may include a first joint part connected to the dyno load motor, a second joint part connected to the driving shaft module, and a connecting shaft coupled to each of the first joint part and the second joint part in a ‘+’ shape.

The driving shaft module may include a shaft housing coupled to the constant velocity universal joint and a shaft rod coupled to the shaft housing to be movable in an axis direction through one end. The shaft rod may include a spline formed on the other end that is capable of being docked to the output unit of the driving module. The driving shaft module may also include a spring installed in the shaft housing to exert an elastic force on the shaft rod in the axis direction and connected to the shaft rod.

The shaft housing may include a plurality of power transmission grooves formed in an inner surface in the axis direction.

The shaft rod may include a plurality of power transmission protrusions formed on the one end to be coupled to the plurality of power transmission grooves in the axis direction.

The docking guide module may include a lower base plate fixed to the rail frame and an upper base plate disposed at a set distance from the lower base plate by using a plurality of guide rods. The docking guide module may also include a lower shaft chucking holder configured to be movable with respect to the lower base plate in an up-down direction and an upper shaft chucking holder disposed at a position corresponding to the lower shaft chucking holder and configured to be movable with respect to the upper base plate in the up-down direction.

The docking guide module may include at least one lower lifting cylinder installed on the lower base plate and a lower lifting plate connected to the at least one lower lifting cylinder and having a top to which the lower shaft chucking holder is fixed. The docking guide module may also include at least one upper lifting cylinder installed on the upper base plate and an upper lifting plate connected to the at least one upper lifting cylinder and having a bottom to which the upper shaft chucking holder is fixed.

The lower lifting plate and the upper lifting plate may be coupled to the plurality of guide rods to be movable in the up-down direction by using a plurality of bushings.

The docking guide module may further include a plurality of ball plungers respectively installed on the lower shaft chucking holder and the upper shaft chucking holder to be able to permit rolling rotations.

The lower shaft chucking holder may include a lower chucking groove supporting a lower part of the driving shaft module.

The upper shaft chucking holder may include an upper chucking groove supporting an upper part of the driving shaft module.

The plurality of ball plungers may be installed in the lower chucking groove and the upper chucking groove to be able to permit the rolling rotations.

The driving shaft module may be in rolling contact with the plurality of ball plungers while being held by the lower shaft chucking holder and the upper shaft chucking holder.

The driving shaft module may be rotated at the rotation speed set by the dyno load motor and the constant velocity universal joint and may be docked to the output unit of the driving module.

The driving module testing device for an electric vehicle according to an embodiment of the disclosure may proactively verify quality problems of the driving module that may occur during actual vehicle driving.

Other effects that may be acquired or anticipated by the embodiments of the disclosure are disclosed directly or implicitly in the detailed description of the embodiments of the disclosure. In other words, various effects that may be expected based on the embodiments of the disclosure are disclosed in the detailed description provided below.

### BRIEF DESCRIPTION OF THE DRAWINGS

The drawings are provided only for reference to describe embodiments of the disclosure. The spirit of the disclosure should not be construed as being limited to or by the accompanying drawings.

FIG. 1 is a block diagram schematically showing a driving module testing device for an electric vehicle according to an embodiment of the disclosure.

FIG. 2 is a side view showing a driving module testing device for an electric vehicle according to an embodiment of the disclosure.

FIG. 3 is a perspective view showing a dynamometer unit applied to a driving module testing device for an electric vehicle according to an embodiment of the disclosure.

FIG. 4 is a side view showing a dynamometer unit applied to a driving module testing device for an electric vehicle according to an embodiment of the disclosure.

FIG. 5 is an assembled perspective view showing a driving shaft module of a dynamometer unit applied to a driving module testing device for an electric vehicle according to an embodiment of the disclosure.

FIG. 6 is an exploded perspective view showing a driving shaft module of a dynamometer unit applied to a driving module testing device for an electric vehicle according to an embodiment of the disclosure.

FIGS. 7 and 8 are diagrams each showing a docking guide module of a dynamometer unit applied to a driving module testing device for an electric vehicle according to an embodiment of the disclosure.

FIG. 9 is a diagram for describing an operation of a driving module testing device for an electric vehicle according to an embodiment of the disclosure.

It should be understood that the drawings referenced above are not necessarily drawn to scale and present a rather simplified representation of various features showing the basic principles of the disclosure. For example, specific design features of the disclosure, including a specific dimension, orientation, position, and/or shape will be determined in part by the particular intended application and environment of use.

### DETAILED DESCRIPTION OF THE EMBODIMENTS

Hereinafter, embodiments of the disclosure are described in detail with reference to the accompanying drawings so that those of ordinary skill in the art to which the disclosure pertains may practice the technical concepts or the disclosure. However, the embodiments of the disclosure may be modified in various different forms and are not limited to the embodiments provided in the specification.

A portion unrelated to the description may have been omitted in order to more effectively describe the technical concepts of the disclosure. The same or similar components are denoted by the same reference numerals throughout the specification, including the drawings.

In addition, the size and thickness of each component shown in the accompanying drawings may be arbitrarily provided for convenience of explanation. Therefore, the disclosure is not necessarily limited to contents shown in the accompanying drawings, and the dimensions may be exaggerated in the drawings to more clearly represent several portions and regions.

Terms used in the specification are only provided to describe a specific embodiment of the disclosure and are not intended to limit the disclosure. Terms of a single number or singular nature used herein are intended to include the plural number or plural nature unless the context clearly indicates otherwise.

It is to be understood that terms such as “comprise”, “have”, or “include”, and variations thereof, used in the specification specify the presence of features, numerals, steps, operations, elements, and/or components. Such terms do not preclude the presence or addition of one or more other features, numerals, steps, operations, components, and/or groups thereof.

In addition, the term “coupled” used herein indicates a physical relationship between two components directly connected to each other or indirectly connected to each other through one or more intermediate components.

In addition, the expression “operably connected” or similar expressions in the specification may indicate that at least two members are directly or indirectly connected to each other to thus transmit power. However, two members operably connected to each other may not be always rotated at the same speed and in the same direction.

Furthermore, terms used herein such as “vehicle”, “of a vehicle”, “automobile”, or other similar terms used in the specification generally include vehicles. Thus, such terms encompass a passenger vehicle, a sports utility vehicle (SUV), a bus, a truck, or various commercial vehicles. Such terms may include a hybrid vehicle equipped with a high-voltage battery, an electric vehicle, a hybrid electric vehicle, an electric vehicle-based purpose built vehicle (PBV), or a hydrogen-powered vehicle (commonly referred to as a “hydrogen electric vehicle” by those of ordinary skill in the art).

Hereinafter, embodiments of the disclosure are described in detail with reference to the accompanying drawings.

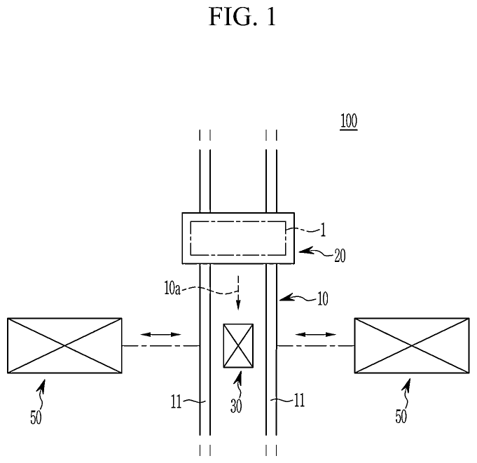

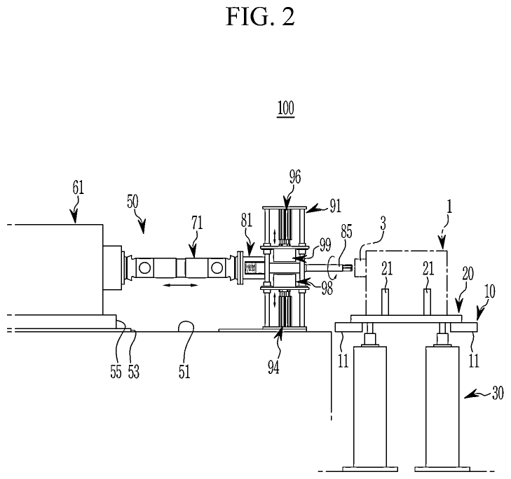

FIG. 1 is a block diagram schematically showing a driving module testing device for an electric vehicle according to an embodiment of the disclosure. FIG. 2 is a side view showing a driving module testing device for an electric vehicle according to an embodiment of the disclosure.

Referring to FIGS. 1 and 2, a driving module testing device 100 for an electric vehicle according to the embodiment of the disclosure may be applied to a driving module manufacturing system that is utilized in manufacturing a driving module 1. In one example, the driving module 1 may be a power electric (PE) system for an electric vehicle.

Here, the driving module 1 may be configured as a driving system for an electric vehicle. The driving module 1 may thus include an electric motor, a reducer, an inverter, a controller, a cooling unit, and a housing are integrated with each other.

The driving module testing device 100 for an electric vehicle may be applied to a driving module testing process for testing the durability and performance of the driving module 1 in a design and development stage of the driving module 1.

For example, in the testing process of the driving module 1, testing items of the driving module 1 may include an excitation test and a dyno load test. The excitation test may test the durability of the driving module 1 by applying vibration to the driving module 1. In addition, the dyno load test may test driving performance or the like of the driving module 1 by applying a dynamometer load, i.e., a dyno load to an output unit 3 (e.g., output shaft) of the driving module 1.

In this specification, a reference direction for explaining the following components may be set as a front-to-back direction, a left-right direction, and an up-down direction, in one example, based on the drawings.

A definition of the direction as described above is relative, and the direction may depend on a reference position or the like of the device 100. Accordingly, the reference direction is not necessarily limited to the reference direction in this embodiment.

Further, in this specification, an “upper end portion”, “upper part”, “upper end”, or

“upper surface” of a component may indicate the end portion, part, end, or surface of a component disposed on a relatively upper side as shown in the drawings. A “lower end portion”, “lower part”, “lower end”, or “lower surface” of a component may indicate the end portion, part, end, or surface of a component disposed on a relatively lower side as shown in the drawings.

Furthermore, in this specification, an end of a component (e.g., one end, another end, or the like) may indicate an end of the component in any one direction. An end portion of a component (e.g., one end portion, the other end portion, or the like) may indicate a certain portion of the component including its end.

The driving module testing device 100 for an electric vehicle according to an embodiment of the disclosure may simulate an environment of an actual vehicle condition by have a simple configuration and allow the integrated excitation test and dyno load test of the driving module 1.

To this end, the driving module testing device 100 may include a conveyor 10, a pallet 20, an excitation unit 30, and a dynamometer unit 50.

In an embodiment of the disclosure, the conveyor 10 may transport the pallet 20 described below along a set transport path 10a.

The conveyor 10 may include a conveyor device known to those of ordinary skill in the art that transports a transport target by a roller type arrangement or a sprocket type arrangement to transport the pallet 20 along a conveyor rail 11.

In an embodiment of the disclosure, the pallet 20 may fix the driving module 1, i.e., the driving module 1 may be fixed to the pallet 20. The pallet 20 may be transported along the transport path 10a by the conveyor 10. Here, the pallet 20 may be simulated as a body of an actual vehicle mounted with the driving module 1.

The pallet 20 may include a plurality of fixing members 21 fixing the driving module 1. Each of the plurality of fixing members 21 may be a clamp for clamping the driving module 1 or may be a fastening jig fastened to the driving module 1.

In an embodiment of the disclosure, the excitation unit 30 may apply vibration to the driving module 1 by using the pallet 20 to perform the excitation test on the driving module 1.

For example, the excitation unit 30 may include a multi-axis exciter capable of testing (or simulating) a feature of vibration of the driving module 1 that would occur during actual vehicle driving conditions.

Here, the excitation unit 30 may simulate 6 degrees of freedom, such as 3-axis translational movement and 3-axis rotational movement (e.g., pitching, yawing, and rolling) generated in the driving module 1.

Furthermore, the features of vibration applied to the driving module 1 by the excitation unit 30 may be collected by a sensor (not shown) attached to the driving module 1.

The excitation unit 30 according to an embodiment of the disclosure may be installed or disposed at a position corresponding to the transport path 10a of the conveyor 10. For example, the excitation unit 30 may be installed below the conveyor 10.

In one example, the excitation unit 30 may be docked or connected to the driving module 1 by an electromagnet method known to those of ordinary skill in the art. In another example, the excitation unit 30 may be docked or connected to the driving module 1 by a clamping method known to those of ordinary skill in the art.

In addition, the excitation unit 30 may be lifted from below the conveyor 10 to the transport path 10a and may be docked to the driving module 1 by the electromagnet method or the clamping method.

In an embodiment of the disclosure, the dynamometer unit 50 may apply a set load or torque to the output unit 3 of the driving module 1 fixed to the pallet 20 to perform the dyno load test to measure the driving performance or the like of the driving module 1.

The dynamometer unit 50 may be installed or configured to be movable in a direction (e.g., the front-to-back direction) that intersects the transport path 10a (e.g., the left-right direction) of the conveyor 10.

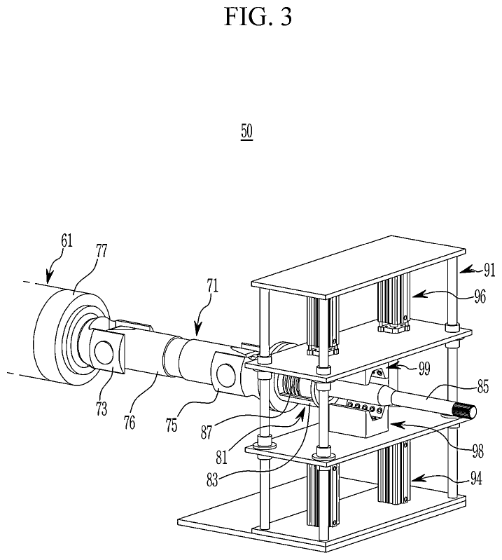

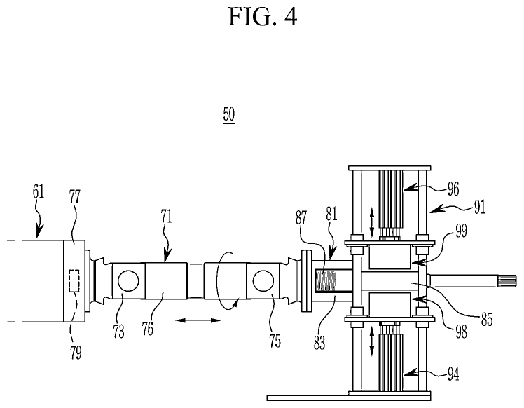

FIG. 3 is a perspective view showing the dynamometer unit applied to the driving module testing device for an electric vehicle according to an embodiment of the disclosure. FIG. 4 is a side view showing the dynamometer unit applied to the driving module testing device for an electric vehicle according to an embodiment of the disclosure.

Referring to FIGS. 1-4, the dynamometer unit 50 according to an embodiment of the disclosure may include a rail frame 51 (see FIG. 2), a slide frame 55 (see FIG. 2), a dyno load motor 61, a constant velocity universal joint 71, a driving shaft module 81, and a docking guide module 91.

In an embodiment of the disclosure, the rail frame 51 may be installed on a floor of a process workshop. The rail frame 51 may include a guide rail 53 (see FIG. 2) disposed on the top thereof. The guide rail 53 may be disposed along a direction that intersects the transport path 10a of the conveyor 10.

Here, two of the rail frames 51 may respectively be disposed on both sides of the conveyor 10 with the conveyor 10 positioned therebetween in the direction that intersects the transport path 10a.

In an embodiment of the disclosure, the slide frame 55 may be slidably coupled to the guide rail(s) 53 of the rail frame(s) 51. The slide frame 55 may be configured to reciprocatingly slide along the guide rail 53 in the direction that intersects the transport path 10a of the conveyor 10.

Here, the slide frame 55 may be reciprocated along the guide rail 53 by an operation of a drive source known to those of ordinary skill in the art. The drive source may include a motor, a guide mechanism, a lead screw, or a ball screw in some examples. In another example, the slide frame 55 may be reciprocated along the guide rail 53 by an operation of a working cylinder known to those of ordinary skill in the art.

In an embodiment of the disclosure, the dyno load motor 61 may generate a rotational driving force of the set number of rotations and torque that is applied to the output unit 3 of the driving module 1.

The dyno load motor 61 may be installed on the slide frame 55. In one example, the dyno load motor 61 may include a servo motor that may perform servo control on a rotation direction and a rotation speed.

In an embodiment of the disclosure, the constant velocity universal joint 71 may transmit the rotational driving force generated by the dyno load motor 61 to the driving shaft module 81 described below.

The constant velocity universal joint 71 may equally transmit the rotational driving force of the dyno load motor 61 to the driving shaft module 81 without changing a rotation angle speed even when a rotation axis of the dyno load motor 61 and the driving shaft module 81 are not disposed in a straight line in an axis direction.

The constant velocity universal joint 71 may be connected to the dyno load motor 61 through one end and may be connected to the driving shaft module 81 through the other end. As shown in FIGS. 3 and 4, the constant velocity universal joint 71 may include a first joint part 73, a second joint part 75, and a connecting shaft 76.

The first joint part 73 may be connected to the dyno load motor 61. The dyno load motor 61 and the first joint part 73 may be connected to each other through a coupler 77. A torque sensor 79 may be installed in the coupler 77. The torque sensor 79 may measure in real time the torque applied from the dyno load motor 61 to the constant velocity universal joint 71.

The second joint part 75 may be connected to the driving shaft module 81 described below. In addition, the connecting shaft 76 may be a driving transmission shaft connecting the first joint part 73 and the second joint part 75 to each other.

Here, the connecting shaft 76 may be joined to each of the first joint part 73 and the second joint part 75 in a plus or ‘+’ shape. Accordingly, those of ordinary skill in the art also refer to the constant velocity universal joint 71 as a double cross-type constant velocity universal joint.

In an embodiment of the disclosure, the driving shaft module 81 may receive the rotational driving force generated by the dyno load motor 61 through the constant velocity universal joint 71.

In addition, the driving shaft module 81 may be docked to the output unit 3 of the driving module 1 and may transmit the rotational driving force to the output unit 3.

The driving shaft module 81 may be disposed in the front-to-back direction that intersects the transport path 10a of the conveyor 10 and may be connected to the second joint part 75 of the constant velocity universal joint 71.

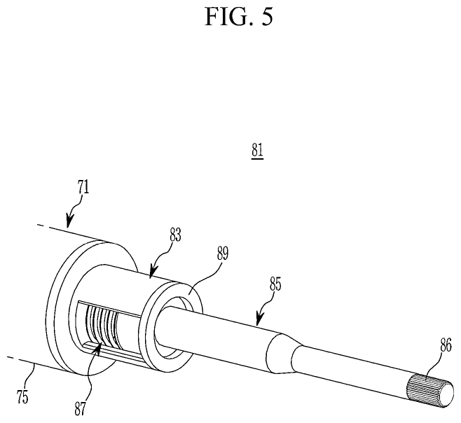

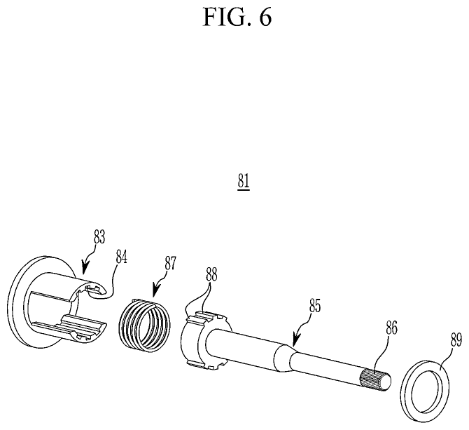

FIG. 5 is an assembled perspective view showing the driving shaft module of the dynamometer unit applied to the driving module testing device for an electric vehicle according to an embodiment of the disclosure. FIG. 6 is an exploded perspective view showing the driving shaft module of the dynamometer unit applied to the driving module testing device for an electric vehicle according to an embodiment of the disclosure.

Referring to FIGS. 1-6, the driving shaft module 81 according to an embodiment of the disclosure may include a shaft housing 83, a shaft rod 85, and a spring 87.

The shaft housing 83 may be coupled to the second joint part 75 of the constant velocity universal joint 71. In one example, the shaft housing 83 may have a shape of a cylinder where one side (e.g., front side) is closed and the other side (e.g., rear side) is open.

The shaft rod 85 may be docked, i.e., coupled or connected to the output unit 3 of the driving module 1 as shown in FIG. 1. The shaft rod 85 may be coupled to the shaft housing 83 to be movable in the axis direction (e.g., axial direction or front-to-back direction) through one end.

The shaft rod 85 may include a spline 86 formed on the other end. The spline 86 may be docked (e.g., spline-coupled) to the output unit 3 of the driving module 1 in the axis direction.

Furthermore, the shaft rod 85 may be coupled to an inner surface of the shaft housing 83 in a spline type connection. Accordingly, the shaft rod 85 may be moved in the axis direction and may transmit the rotational driving force to the output unit 3 of the driving module 1.

To this end, the shaft housing 83 may include a plurality of power transmission grooves 84 formed in the inner surface in the axis direction. In addition, the shaft rod 85 may include a plurality of power transmission protrusions 88 formed on one end to be coupled to the plurality of power transmission grooves 84 in the axis direction.

The spring 87 may exert an elastic force on the shaft rod 85 in the axis direction. The spring 87 may be installed in the shaft housing 83 and may be connected to the shaft rod 85.

Reference numeral 89, a shown in FIG. 6, indicates a stopper coupled to the shaft housing 83 to prevent the shaft rod 85 from falling out of the shaft housing 83.

Referring to FIGS. 1-6, in an embodiment of the disclosure, the docking guide module 91 may support the shaft rod 85 of the driving shaft module 81.

In addition, the docking guide module 91 may guide the driving shaft module 81 to the driving module 1 while allowing rotation of the driving shaft module 81.

The docking guide module 91 may be installed on the rail frame(s) 51.

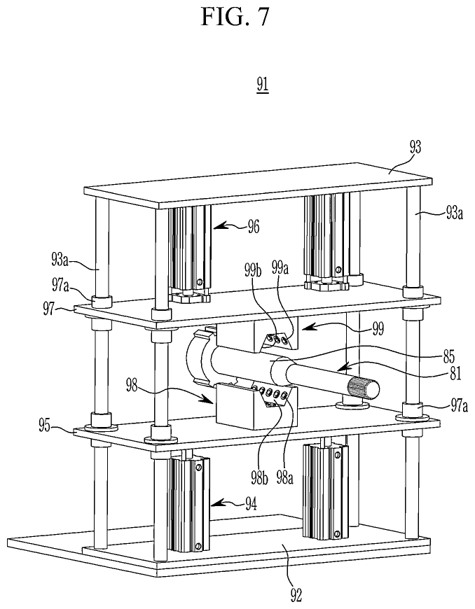

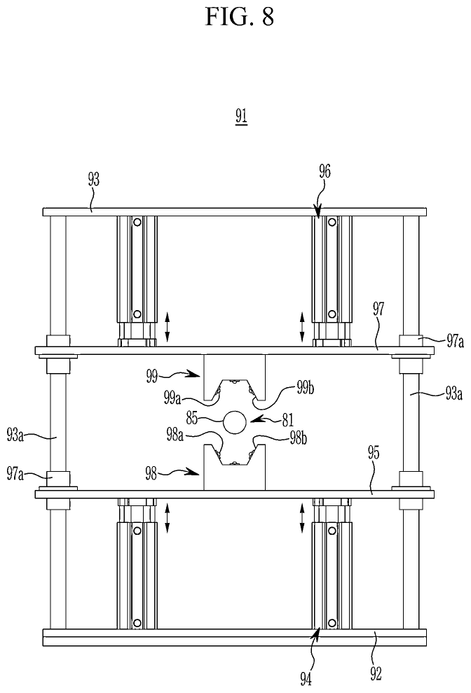

FIGS. 7 and 8 are diagrams each showing the docking guide module of the dynamometer unit applied to the driving module testing device for an electric vehicle according to an embodiment of the disclosure.

Referring to FIGS. 7 and 8, the docking guide module 91 according to an embodiment of the disclosure may include a lower base plate 92, an upper base plate 93, at least one lower lifting cylinder 94, a lower lifting plate 95, at least one upper lifting cylinder 96, an upper lifting plate 97, a lower shaft chuck, i.e., chucking holder 98, an upper shaft chuck, i.e., chucking holder 99, and a plurality of ball plungers 98a and 99a.

The lower base plate 92 may be fixed to the rail frame(s) 51. The upper base plate 93 may be disposed at a set distance from the lower base plate 92 by using a plurality of guide rods 93a.

Here, each lower end of the plurality of guide rods 93a may be coupled to the lower base plate 92 and each upper end of the plurality of guide rods 93a may be coupled to the upper base plate 93.

At least one lower lifting cylinder 94 may be installed on an upper surface of the lower base plate 92. In one example, at least one lower lifting cylinder 94 may include a pneumatic cylinder.

The lower lifting plate 95 may be operably connected to at least one lower lifting cylinder 94. The lower lifting plate 95 may be moved along the plurality of guide rods 93a in the up-down direction by forward and backward, i.e., reciprocating operations of at least one lower lifting cylinder 94.

At least one upper lifting cylinder 96 may be installed on a lower surface of the upper base plate 93. In one example, at least one upper lifting cylinder 96 may include a pneumatic cylinder.

The upper lifting plate 97 may be operably connected to at least one upper lifting cylinder 96. The upper lifting plate 97 may be moved along the plurality of guide rods 93a in the up-down direction by forward and backward, i.e., reciprocating operations of at least one upper lifting cylinder 96.

Here, the lower lifting plate 95 and the upper lifting plate 97 may be coupled to the plurality of guide rods 93a in the up-down direction by using a plurality of bushings 97a.

The lower shaft chucking holder 98 may surround a lower part of the shaft rod 85 of the driving shaft module 81 and support (or chuck) the lower part.

The lower shaft chucking holder 98 may be installed to be substantially movable with respect to the lower base plate 92 in the up-down direction. Furthermore, the lower shaft chucking holder 98 may have the form of a block and be fixed to an upper surface of the lower lifting plate 95.

The lower shaft chucking holder 98 may include a lower chucking groove 98b surrounding and supporting the lower part of the shaft rod 85. In one example, the lower chucking groove 98b may be formed in the lower shaft chucking holder 98 while having an approximately U-shape.

The upper shaft chucking holder 99 may surround and support (or chuck) an upper part of the shaft rod 85.

The upper shaft chucking holder 99 may be installed or disposed at a position corresponding to the lower shaft chucking holder 98 to be substantially movable with respect to the upper base plate 93 in the up-down direction. Furthermore, the upper shaft chucking holder 99 may have the form of the block and be fixed to a lower surface of the upper lifting plate 97.

The upper shaft chucking holder 99 may include an upper chucking groove 99b surrounding and supporting the upper part of the shaft rod 85. In one example, the upper chucking groove 99b may be formed in the upper shaft chucking holder 99 while having an approximately inverted U-shape.

In addition, the plurality of ball plungers 98a and 99a may guide the shaft rod 85 to the driving module 1 while allowing the rotation of the shaft rod 85.

The plurality of ball plungers 98a and 99a may respectively be installed on the lower shaft chucking holder 98 and the upper shaft chucking holder 99, to be able to permit or facilitate rolling rotation. The plurality of ball plungers 98a and 99a may respectively be mounted in the lower chucking groove 98b and the upper chucking groove 99b to be able to permit rolling the rotation.

Hereinafter, an operation of the driving module testing device 100 for an electric vehicle according to an embodiment of the disclosure configured as above is described in detail with reference to FIGS. 1-9.

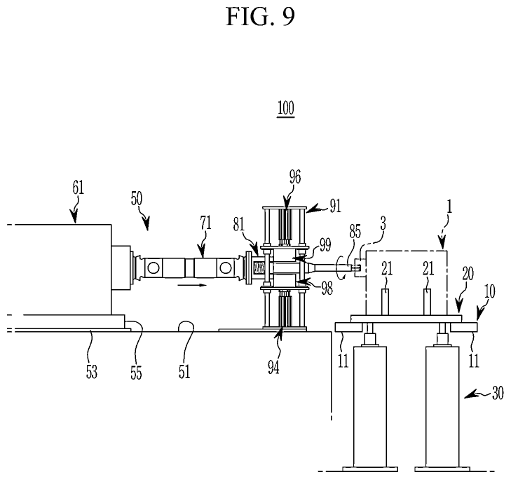

FIG. 9 is a diagram for explaining the operation of the driving module testing device for an electric vehicle according to an embodiment of the disclosure.

First, referring to FIGS. 1-9, in an embodiment of the disclosure, the driving module 1 may be fixed to the fixing member 21 of the pallet 20.

In an embodiment of the disclosure, the pallet 20 as described above may be transported along the transport path 10a of the conveyor 10 and may be disposed at a set location, for example, above the excitation unit 30.

In an embodiment of the disclosure, the dyno load motor 61 and driving shaft module 81 of the dynamometer unit 50 may be connected to each other by the constant velocity universal joint 71.

A connection assembly of the dyno load motor 61, the constant velocity universal joint 71, and the driving shaft module 81 may be moved backward along the guide rail(s) 53 of the rail frame(s) 51 by using the slide frame 55.

In an embodiment of the disclosure, the lower shaft chucking holder 98 of the docking guide module 91 may be moved upward by a forward operation of at least one lower lifting cylinder 94 (see FIG. 9).

In an embodiment of the disclosure, the upper shaft chucking holder 99 of the docking guide module 91 may be moved downward by a forward operation of at least one upper lifting cylinder 96 (see FIG. 9).

Here, the lower shaft chucking holder 98 may be moved upward together with the lower lifting plate 95. The lower lifting plate 95 may be moved upward along the plurality of guide rods 93a by using the plurality of bushing 97a.

In addition, the upper shaft chucking holder 99 may be moved downward together with the upper lifting plate 97. The upper lifting plate 97 may be moved downward along the plurality of guide rods 93a by using the plurality of bushings 97a.

Here, the lower shaft chucking holder 98 may surround and chuck the lower part of the shaft rod 85 of the driving shaft module 81 by using the lower chucking groove 98b. The plurality of the ball plungers 98a installed in the lower chucking groove 98b may be in rolling contact with the lower part of the shaft rod 85.

In addition, the upper shaft chucking holder 99 may surround and chuck the upper part of the shaft rod 85 by using the upper chucking groove 99b. The plurality of ball plungers 99a installed in the upper chucking groove 99b may be in rolling contact with the upper part of the shaft rod 85.

Furthermore, the lower shaft chucking holder 98 and the upper shaft chucking holder 99 as described above may support the shaft rod 85 at their positions each corresponding to the output unit 3 of the driving module 1.

The shaft rod 85 described above may be disposed in the straight line, i.e., aligned with or concentric with the rotation axis of the dyno load motor 61 in the axis direction or may not be disposed in the straight line depending on a vertical height of the output unit 3 of the driving module 1.

Here, the shaft rod 85 may be disposed at the position corresponding to the output unit 3 of the driving module 1 by the constant velocity universal joint 71 even when the shaft rod 85 is not disposed in the straight line with the rotation axis of the dyno load motor 61 in the axis direction.

The position change of the shaft rod 85 described above may be achieved through a vertical movement of each of the lower shaft chucking holder 98 and the upper shaft chucking holder 99 based on each operation of at least one lower lifting cylinder 94 and at least one upper lifting cylinder 96.

In this state, the connection assembly of the dyno load motor 61, the constant velocity universal joint 71, and the driving shaft module 81 may be moved forward along the guide rail 53 of the rail frame 51 by using the slide frame 55.

Here, the shaft rod 85 of the driving shaft module 81 may be rotated at the number of rotations (for example, 5 rpm) set by the operation of the dyno load motor 61.

The shaft rod 85 may be rotated by the plurality of ball plungers 98a and 99a of the lower and upper shaft chucking holders 98 and 99.

In addition, the lower shaft chucking holder 98 and the upper shaft chucking holder 99 may guide a forward movement of the shaft rod 85 by using the plurality of ball plungers 98a and 99a.

As described above, the shaft rod 85 may be rotated and moved forward at the set number of rotations and may be docked to the output unit 3 of the driving module 1.

Here, the shaft rod 85 may be spline-coupled to the output unit 3 of the driving module 1 by using the spline 86 and may be docked to the output unit 3.

Here, a reaction force of the output unit 3 may overcome an elastic force of the spring 87 and be moved backward when the shaft rod 85 is not spline-coupled to the output unit 3 of the driving module 1 by using the spline 86.

Therefore, the shaft rod 85 may be rotated at the set number of rotations, and thus may be moved forward by the elastic force of the spring 87 and spline-coupled to the output unit 3 at a moment when the spline 86 is engaged with the output unit 3 of the driving module 1.

The lower shaft chucking holder 98 may be moved downward together with the lower lifting plate 95 by a backward operation of at least one lower lifting cylinder 94 when the shaft rod 85 is completely docked to the output unit 3 of the driving module 1 as described above.

In addition, the upper shaft chucking holder 99 may be moved upward together with the upper lifting plate 97 by a backward or reverse operation of at least one upper lifting cylinder 96.

In this state, the excitation unit 30 may apply vibration to the driving module 1 by using the pallet 20.

The excitation unit 30 may apply vibration to the driving module 1 and may simulate the 6 degrees of freedom, such as the 3-axis translational movement and 3-axis rotational movement of the driving module 1.

Accordingly, the sensor (not shown) attached to the driving module 1 may collect the features of vibration applied to the driving module 1.

In this process, the dyno load motor 61 may generate the rotational driving force of the set number of rotations (e.g., 3000 rpm) and torque (e.g., 2500 NM). This rotational driving force may be transmitted to the shaft rod 85 of the driving shaft module 81 by using the constant velocity universal joint 71.

Accordingly, the shaft rod 85 may apply a load (e.g., dyno load or rotational driving force) of the dyno load motor 61 to the output unit 3 of the driving module 1. The load may be measured in real time by the torque sensor 79.

Here, the shaft rod 85 may be coupled to the plurality of power transmission grooves 84 of the shaft housing 83 through the plurality of power transmission protrusions 88 in the axis direction. Therefore, the rotational driving force may be transmitted to the output unit 3 of the driving module 1.

When vibration and the load are simultaneously applied to the driving module 1 as above, the driving module 1 may be vibrated by the excitation unit 30 and a phase difference may thus occur between the rotation axis of the dyno load motor 61 and the shaft rod 85. This phase difference may cause clearance between the shaft rod 85 and the output unit 3 of the driving module 1.

However, the rotation axis of the dyno load motor 61 and the shaft rod 85 may be connected to each other by using the constant velocity universal joint 71. Therefore, the constant velocity universal joint 71 may provide a degree of freedom to the shaft rod 85 and may compensate for the phase difference described above. Accordingly, the shaft rod 85 may not fall out of or be disconnected from the output unit 3 of the driving module 1 or be damaged.

The driving module testing device 100 for an electric vehicle according to the embodiments of the disclosure as described hereinabove may simulate an environment of actual vehicle driving conditions by using the simple configuration and allow the integrated excitation test and dyno load test of the driving module 1.

Therefore, the driving module testing device 100 for an electric vehicle according to an embodiment of the disclosure may predict a problem or risk that may occur under actual vehicle driving conditions where the driving and vibration characteristics are mixed or co-exist with each other.

As a result, the driving module testing device 100 for an electric vehicle according to an embodiment of the disclosure may proactively verify a quality problem of the driving module 1 that may occur during actual vehicle driving, thus reducing a development schedule of the driving module 1 and preventing any further loss in design and development costs.

Although the embodiments of the disclosure have been described hereinabove, the spirit and scope of the disclosure are not limited to the embodiments described in the specification. Those having ordinary skill in the art should understand that the spirit and scope of the disclosure may suggest other embodiments by adding, changing, deleting, or supplementing a component that also falls within the scope of the disclosure.

<Description of symbols>

| | |
|---|---|
| 1: driving module | 3: output unit |
| 10: conveyor | 10a: transport path |
| 11: conveyor rail | 20: pallet |
| 21: fixing member | 30: excitation unit |
| 50: dynamometer unit | 51: rail frame |
| 53: guide rail | 55: slide frame |
| 61: dyno load motor | 71: constant velocity universal joint |
| 73: first joint part | 75: second joint part |
| 76: connecting shaft | 77: coupler |
| 79: torque sensor | 81: driving shaft module |
| 83: shaft housing | 84: power transmission groove |
| 85: shaft rod | 86: spline |
| 87: spring | 88: power transmission protrusion |
| 91: docking guide module | 92: lower base plate |
| 93: upper base plate | 93a: guide rod |
| 94: lower lifting cylinder | 95: lower lifting plate |
| 96: upper lifting cylinder | 97: upper lifting plate |
| 97a: bush | 98: lower shaft chucking holder |
| 98a, 99a: ball plunger | 98b: lower chucking groove |
| 99: upper shaft chucking holder | |
| 99b: upper chucking groove | |
| 100: driving module testing | |
| device for electric vehicle | |

What is claimed is:

1. A driving module testing device for an electric vehicle, the testing device comprising:
a pallet configured for fixing a driving module for an electric vehicle and to be transported along a transport path set by a conveyor;
an excitation unit disposed at a position that corresponds to the transport path to apply vibration to the driving module by using the pallet; and
a dynamometer unit movable in a direction that intersects the transport path and configured to apply a dyno load to an output unit of the driving module.

2. The testing device of claim 1, wherein the dynamometer unit comprises:
a rail frame; and
a slide frame slidably coupled to the rail frame in the direction that intersects the transport path.

3. The testing device of claim 2, wherein two of the rail frames are respectively disposed on both sides of the conveyor with the conveyor disposed therebetween in the direction that intersects the transport path.

4. A driving module testing device for an electric vehicle, the testing device comprising:
a pallet configured for fixing a driving module for an electric vehicle and to be transported along a transport path set by a conveyor;
an excitation unit disposed at a position that corresponds to the transport path and configured to apply vibration to the driving module by using the pallet;
a slide frame slidably mounted on a rail frame disposed in a direction that intersects the transport path;
a dyno load motor installed on the slide frame;
a constant velocity universal joint connected to the dyno load motor; and
a driving shaft module connected to the constant velocity universal joint and configured to be docked to an output unit of the driving module.

5. The testing device of claim 4, further comprising a docking guide module supporting the driving shaft module and fixed to the rail frame to guide the driving shaft module to the driving module while allowing rotation of the driving shaft module.

6. The testing device of claim 4, wherein the dyno load motor is connected to the constant velocity universal joint through a coupler and wherein a torque sensor is installed in the coupler.

7. The testing device of claim 4, wherein the constant velocity universal joint comprises:
a first joint part connected to the dyno load motor;
a second joint part configured to be connected to the driving shaft module; and
a connecting shaft coupled to each of the first joint part and the second joint part in a ‘+’ shape.

8. The testing device of claim 4, wherein the driving shaft module comprises:
a shaft housing coupled to the constant velocity universal joint;
a shaft rod coupled to the shaft housing to be movable in an axis direction through one end, the shaft rod including a spline formed on another end that is capable of being docked to the output unit of the driving module; and
a spring installed in the shaft housing to exert an elastic force on the shaft rod in the axis direction, the spring connected to the shaft rod.

9. The testing device of claim 8, wherein:
the shaft housing includes a plurality of power transmission grooves formed in an inner surface in the axis direction; and
the shaft rod includes a plurality of power transmission protrusions formed on the one end to be coupled to the plurality of power transmission grooves in the axis direction.

10. The testing device of claim 5, wherein the docking guide module comprises:
a lower base plate fixed to the rail frame;
an upper base plate disposed at a set distance from the lower base plate by using a plurality of guide rods;
a lower shaft chucking holder installed to be movable with respect to the lower base plate in an up-down direction; and
an upper shaft chucking holder installed at a position that corresponds to the lower shaft chucking holder to be movable with respect to the upper base plate in the up-down direction.

11. The testing device of claim 10, wherein the docking guide module comprises:
at least one lower lifting cylinder installed on the lower base plate;
a lower lifting plate connected to the at least one lower lifting cylinder and having a top to which the lower shaft chucking holder is fixed;
at least one upper lifting cylinder installed on the upper base plate; and
an upper lifting plate connected to the at least one upper lifting cylinder and having a bottom to which the upper shaft chucking holder is fixed.

12. The testing device of claim 11, wherein the lower lifting plate and the upper lifting plate are coupled to the plurality of guide rods to be movable in the up-down direction by via a plurality of bushings.

13. The testing device of claim 10, wherein the docking guide module further includes a plurality of ball plungers respectively installed on the lower shaft chucking holder and the upper shaft chucking holder to be able to permit rolling rotation.

14. The testing device of claim 13, wherein:
the lower shaft chucking holder includes a lower chucking groove supporting a lower part of the driving shaft module;
the upper shaft chucking holder includes an upper chucking groove supporting an upper part of the driving shaft module; and
the plurality of ball plungers are installed in the lower chucking groove and the upper chucking groove to be able to permit the rolling rotation.

15. The testing device of claim 13, wherein the driving shaft module is in rolling contact with the plurality of ball plungers while held on the lower shaft chucking holder and the upper shaft chucking holder, is rotated at a rotation speed set by the dyno load motor and the constant velocity universal joint, and is docked to the output unit of the driving module.
